(19) United States
(12) Patent Application Publication
(10) Pub. No.: US 2019/0342959 A1
(43) Pub. Date: Nov. 7, 2019

(54) LIGHT EMITTING ELEMENT DRIVING DEVICE AND DRIVING METHOD THEREOF

(71) Applicant: DELTA ELECTRONICS, INC., Taoyuan City (TW)

(72) Inventors: Ching-Ho CHOU, Taoyuan City (TW); Tsu-Hua AI, Taoyuan City (TW)

(21) Appl. No.: 16/149,146

(22) Filed: Oct. 2, 2018

(30) Foreign Application Priority Data
May 4, 2018 (CN) 201810421355.6

(51) Int. Cl. H05B 33/08; H02J 7/00; H02J 7/06

(52) U.S. Cl. CPC H05B 33/0815; H02J 7/345; H02J 7/06; H02J 7/0068

(57) ABSTRACT

A light emitting element driving device includes a first energy storage element, a power source, and a converter circuit. The power source is electrically connected to the first energy storage element via the light emitting element in order to provide current to the light emitting element and to charge the first energy storage element. The converter circuit is electrically connected to the power source and the first energy storage element, and includes an inductance. When the converter circuit is in the first operational status, the first energy storage element charges the inductance. When the converter circuit is in the second operational status, the inductance is fed back to the power source.

### RELATED APPLICATIONS

This application claims priority to China Application Serial Number 201810421355.6, filed May 4, 2018, which is herein incorporated by reference in its entirety.

### BACKGROUND

### Technical Field

The present disclosure relates to a light emitting element driving device. More particularly, a high efficiency conversion device for processing a part of load energy to drive a light emitting element.

### Description of Related Art

Light-emitting diode (LED) is a kind of a light emitting device driven by the current. The brightness of the LED is adjusted by controlling the current flowing through the LED. In the prior art, when the LED is connected to a DC voltage source for operation, the operating current of the LED is adjusted by a resistor, which is connected in series with the LED. The advantage of this circuit is simple and the disadvantage is low efficiency. In another prior art, the operating current of the LED is adjusted through a power converter. Compared with the above circuit with the series resistance, the circuit with the power converter has higher efficiency. However, in this circuit, the load of the LED is completely through the power converter. If this circuit is applied to the off-line LED driver, when a power factor correction circuit is added to this circuit to form a two-stage architecture, the overall operating efficiency still cannot be improved.

When designing a LED driving device, factors to be considered include the complexity of the circuit structure, the conversion efficiency and the stability of the current. Therefore, how to balance the above factors is very important.

### SUMMARY

One aspect of the present disclosure is a light emitting element driving device. The light emitting element driving device comprises an energy storage element, a power source and a converter circuit. The power source is electrically connected to a positive terminal of the energy storage element through a light emitting element in order to provide a current to the light emitting element and to charge the energy storage element. The converter circuit is electrically connected to the power source and the energy storage element, wherein the converter circuit comprises an inductance. When the converter circuit is in a first operational status, the energy storage element charges the inductance. When the converter circuit is in a second operational status, the inductance is discharged to the power source.

Another aspect of the present disclosure is a driving method of a light emitting element. The driving method comprises the following steps: providing a current to a light emitting element through a power source and charging an energy storage element, wherein the power source is electrically connected to a first terminal of the light emitting element, and a positive terminal of the energy storage element is directly connected to a second terminal of the light emitting element. Turning on a first switch element in order that the energy storage element charges a inductance when the power source provides the current to the light emitting element continuously. Turning off the first switch element in order that the inductance discharge to the power source.

Another aspect of the present disclosure is a light emitting element driving device. The light emitting element driving device comprises an energy storage element, a power source, a inductance, a first switch element and a second switch element. The power source is electrically connected to a positive terminal of the energy storage element through a light emitting element in order to provide a current to the light emitting element and to charge the energy storage element. The inductance is electrically connected to the energy storage element. The first switch element is electrically connected to the energy storage element and the inductance, wherein the energy storage element is configured to charge the inductance when the first switch element is turned on. The second switch element is electrically connected to the inductance and the power source, wherein the inductance discharges to the power source through the second switch element when the first switch element is turned off.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a light emitting element driving device in some embodiments of the present disclosure.

FIG. 2A is a schematic diagram of a light emitting element driving device in a first operational status in some embodiments of the present disclosure.

FIG. 2B is a schematic diagram of a light emitting element driving device in a second operational status in some embodiments of the present disclosure.

FIG. 3 is a waveform diagram of the currents of the light emitting element driving device in some embodiments of the present disclosure.

FIG. 4 is a schematic diagram of a light emitting element driving device in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

With regard to a driving device for LED, the conventional means connect a resistor in series with the LED to serve as a power converter in order that a constant current flow through the LED. The advantage of this means is simple and the disadvantage of this means is low efficiency, and it needs to adjust the resistance according to the LED specification. In order to improve efficiency, many improved power converters have been designed. Common types of power converters include buck converters, boost converters, and buck-boost converters, but the efficiency of these methods is still not ideal.

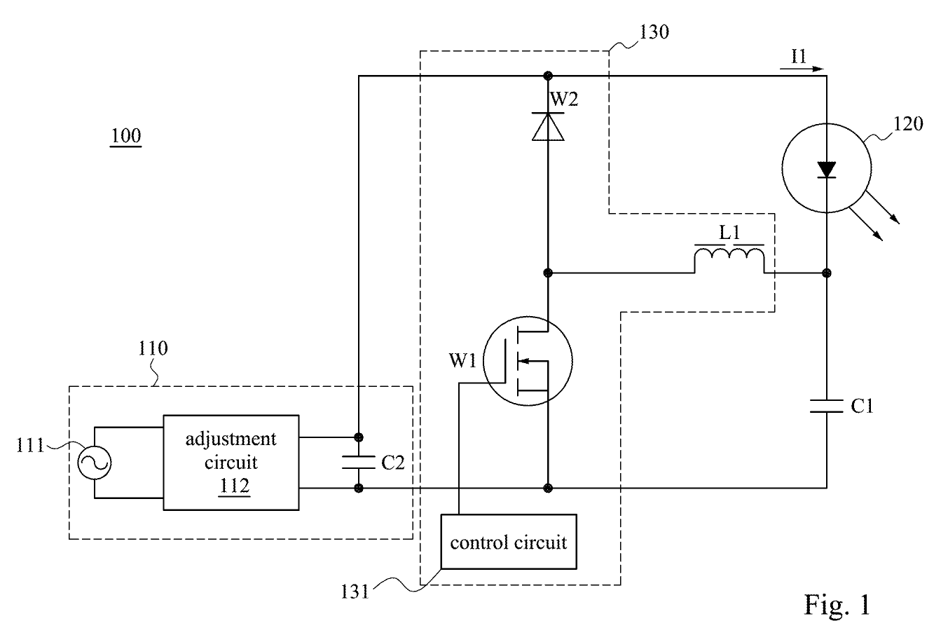

Please refer to FIG. 1, which are some embodiments of a light emitting element driving device 100 in the present disclosure. The light emitting element driving device 100 includes an energy storage element C1, a power source 110, and a converter circuit 130. The positive terminal of the energy storage element C1 is directly connected to the negative terminal of at least one light emitting element 120. The power source 110 is connected to the energy storage element C1 via the light emitting element 120 to provide the first current I1 to the light emitting element 120 and to charge the energy storage element C1. In some embodiments, the light emitting element 120 and the energy storage element C1 is connected in series, and the series branch of the light emitting element 120 and the energy storage element C1 is connected in parallel with the power source 110. In particular, the power source 110 of FIG. 1 is only a schematic diagram, and it should be understood by those skilled in the art that any device that can provide power to the light emitting element can be referred to as the power source 110. In some embodiments, the energy storage element C1 includes a capacitor such as an aluminum capacitor, a metallized film capacitor, a multilayer ceramic capacitor, or other type of capacitor. The light emitting element 120 includes the LED, but not limited thereto.

The converter circuit 130 is electrically connected to the power source 110 and the energy storage element C1. The converter circuit 130 at least includes an inductance L1. When the converter circuit 130 is in a first operational status, the energy storage element C1 charges the inductance L1. When the converter circuit 130 is in a second operational status, the inductance L1 is discharged (or fed back) to the power source 110 to achieve the function of energy-recycling.

This present disclosure controls the charging and discharging of the inductance L1 repeatedly, so that the energy of the energy storage element C1 passes through the inductance L1 and is fed back to the power source 110. Accordingly, the voltage across the energy storage element C1 is controlled, thereby stabilizing the voltage across the light emitting element 120 and the first current I1.

The circuit architecture of the present disclosure is to connect the output of the power source 110 in parallel to the series branch of the light emitting element 120 and the energy storage element C1. In this circuit architecture, the driving device 100 has the phenomenon of “V110=V120+VC1”. That is, the cross voltage across the power source 110 (V110) is equal to the sum of the cross-voltages of the light emitting element 120 and the energy storage element C1. In the present disclosure, since the converter circuit 130 process part of the load energy and can be energy-recycling, the driving apparatus 100 has a better conversion efficiency than the conventional power converter. In particular, when the power source 110 is the output of another stage converter circuit for providing power to the light emitting element 120, the overall conversion efficiency improved by the present disclosure will be more apparent.

In some embodiments, the power source 110 includes an AC voltage source 111, an adjustment circuit 112, and an input capacitor C2. The adjustment circuit 112 is electrically connected to the AC voltage source 111 for receiving an AC voltage generated by the AC voltage source 111 and outputting an adjustment voltage. In some embodiments, the adjustment circuit 112 is a Power Factor Correction (PFC), a High Voltage Direct Current (HVDC) or a bridge rectifier. In some embodiments, the power source 110 may be a battery. The input capacitor C2 is electrically connected to the output of the adjustment circuit 112 for receiving the adjustment voltage. The input capacitor C2 provides energy to the light emitting element 120 and the energy storage element C1 to provide a first current I1 to the light emitting element 120. In some embodiments, the input capacitor C2 is connected in parallel with the series branch of the light emitting element 120 and the energy storage element C1, and is used to receive the energy of energy-recycling from the inductance L1.

In some embodiments, the converter circuit 130 of the light emitting element driving device 100 further includes a first switch element W1 and a second switch element W2. The first switch element W1 is electrically connected to the inductance L1 and the energy storage element C1. The second switch element W2 is electrically connected to the inductance L1 and the power source 110. When the first switch element W1 is turned on, the energy storage element C1 is configured to charge the inductance L1. The “charge” described here means that the second current I2 flowing through the inductance L1 is gradually increased to store energy. When the second switch element W2 is turned on or the first switch element W1 is turned off, the inductance L1 is configured to discharge to the power source 110. Compared with the conventional power converter, the circuit architecture of the present disclosure provides a current path to the power source 110 through the light emitting element 120 and the energy storage element C1, so that the conversion efficiency can be improved.

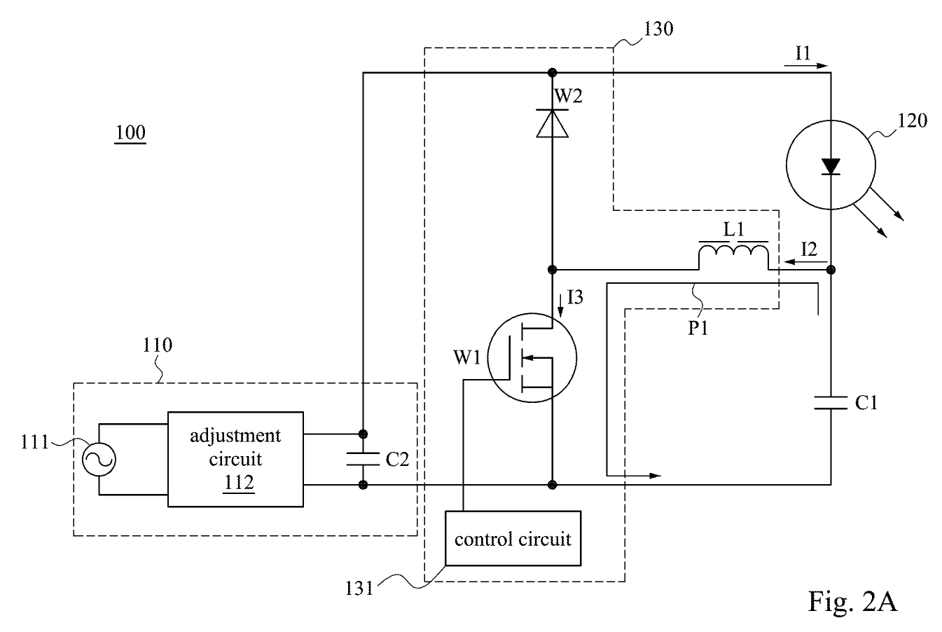

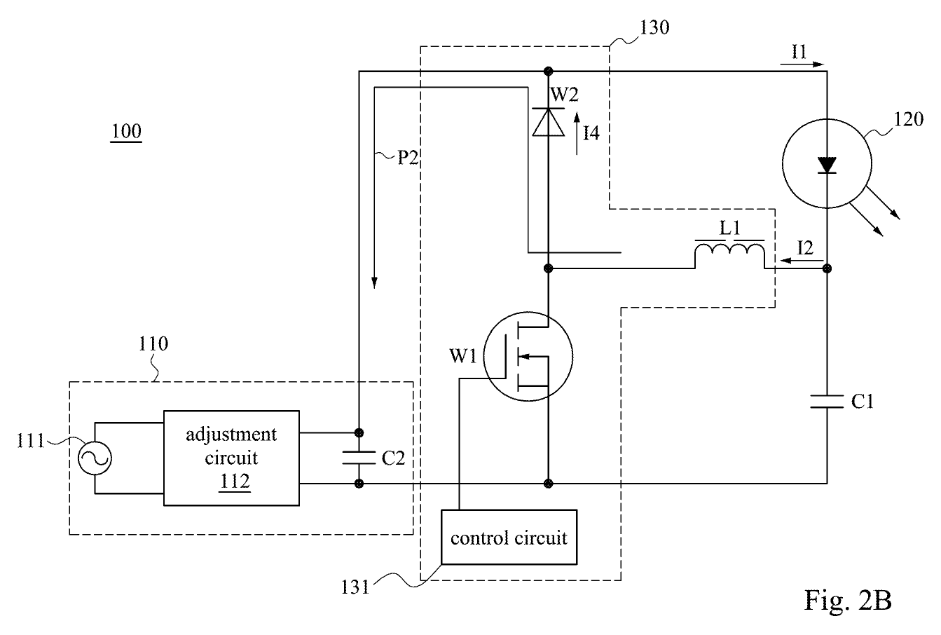

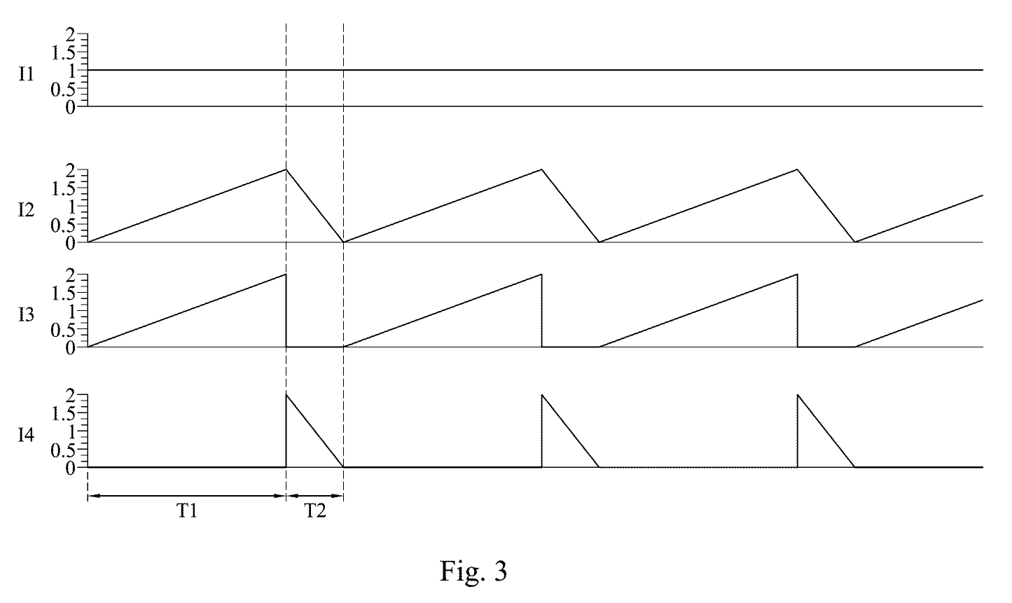

In order for those skilled in the art to understand the technology of the present disclosure, the operation of the light emitting element driving device will be described here. Please refer to FIG. 1-3, FIG. 2A and FIG. 2B are schematic diagrams of the converter circuit 130 in the first operational status and the second operational status, respectively. FIG. 3 is a waveform diagram of currents of the light emitting element driving device 100.

First, as shown in FIG. 1, when the power source 110 starts discharging, the power source 110 provides the first current I1 to the light emitting element 120. The power source 110 further charges the energy storage element C1 through the light emitting element 120.

As the voltage stored by the energy storage element C1 increases, the first current I1 provided with the light emitting element 120 will gradually decrease, and the converter circuit 130 will be in the first operational status (As shown in FIG. 3, since C1 is an energy storage device, the variation of the first current I1 is extremely small, the overall current value of the first current I1 is between 0.90 mA and 1.05 mA, it can be considered as a stable DC). As shown in FIG. 2A, in the first operational status, the power source 110 continues to provide the first current I1 to the light emitting element 120. At this time, the first switch element W1 is turned on so that the first switch element W1, the energy storage element C1 and the inductance L1 form a charging path P1, and the energy storage element C1 charges the inductance L1. As shown in FIGS. 2A and 3, when the converter circuit 130 is in the first operational status, a second current I2 is formed on the inductance L1. During a charging period T1, the second current I2 gradually increases. At the same time, a third current I3 flows through the first switch element W1.

Referring to FIGS. 2B and 3, when the first switch element W1 is turned off, the converter circuit 130 will be in the second operational status. In the second operational status, the power source 110 still provides the first current I1 to the light emitting element 120. The energy stored in inductance L1 passes through the second switch element W2 to form a discharge path. In some embodiments, the first switch element W1 is a controllable switch and the second switch element W2 is a diode or a controllable switch. The controllable switch may be a metal-oxide-semiconductor field effect transistor (MOSFET), a gallium nitride (GaN), or a bipolar transistor (BJT), but not limited to this. If the second switch element W2 is a diode, the positive terminal of the diode will be electrically connected to the inductance L1. When the first switch element W1 is turned off, since the electrical characteristic of the inductance L1 is to maintain the second current I2, the second current I2 flows in a direction of the second switch element W2. At this time, the second switch element W2 is turned on, and the fourth current I4 flows through the second switch element W2. The second switch element W2 may also use a controllable switch (e.g., synchronous rectification known to those skilled in the art) to further reduce the loss. People having ordinary skill in the art can understand these contents so it will not be described here. The inductance L1, the second switch element W2, the power source 110, and the energy storage element C1 form a discharge path P2. In a recharging period T2, the inductance L1 discharges (or fed back) the stored energy to the power source 110.

In some embodiments, the first switch element W1 is controlled to switch between turn on and turn off according to a reference signal, so that the inductance L1 is repeatedly charged and discharged (Refer to FIG. 3 for charging period T1 and recharging period T2). Accordingly, the voltage across the energy storage element C1 can be maintained at a predetermined value, thereby allowing the light emitting element 120 to operate at a constant current and maintain the consistency of the light intensity (as mentioned above, the variation range of the first current I1 is much smaller than the current of the first current I1, so it can be regarded as a constant current). In some embodiments, the converter circuit 130 may be operated in a Continuous Conduction Mode (CCM). When the converter circuit 130 is operated in the CCM, the average value of a current in the converter circuit 130 (e.g., the average value of the second current I2) is equal to the average value of the first current I1.

In order to achieve the aforementioned purpose, the converter circuit 130 can use a corresponding control method. In some embodiments, when the converter circuit 130 is further controlled in a Boundary Conduction Mode (BCM) between the CCM and the DCM, the electrical characteristics of the driving device 100 will conform to the identity: “I₁=(I₂₋ₚₑₐₖ)/2”. That is, the first current I1 on the light emitting element 120 is equal to half of the peak current (e.g., the second current I2 flowing through the inductance L1) in the converter circuit 130.

For example, if the power source 110 provides an input voltage of 48 volts, the inductance of the inductance L1 is 40 uH, the expected operating state of the light emitting element 120 is 36 volts and 1050 milliamperes, the first switch element W1 operates at 100 kHz, and the period 78%. At this time, the voltage across the energy storage element C1 should be 12 volts and the peak current in the converter circuit 130 is 2100 milliamps.

Since the converter circuit 130 has the characteristics of the aforementioned identity when operated in the BCM, the driving device 100 can detect the current value of the converter circuit 130 and control the converter circuit 130 to be in the first operational status or the second operational status. In some embodiments, the converter circuit 130 of the light emitting element driving device 100 further includes a control circuit 131. The control circuit 131 is configured to output the control signal to the first switch element W1 according to the reference signal to control the first switch element W1 to turn on or off. The control circuit 131 is further configured to change the time point of turning on or turning off of the first switch element W1 according to the detection current flowing through at least one of the first switch element W1, the second switch element W2, and the inductance L1.

For example, when the detection current reaches a default value (e.g., 2100 mA), the control circuit 131 turns off the first switch element W1 so that the converter circuit 130 is in the second operational status. In some embodiments, when the control circuit 131 controls the first switch element W1 to be turned on, the first switch element W1, the energy storage element C1, and the inductance L1 form a charging path P1. On the other hand, when the control circuit 131 controls the first switch element W1 to be turned off, the second switch element W2 which are turned on, the inductance L1, and the power source 110 will form the discharge path P2.

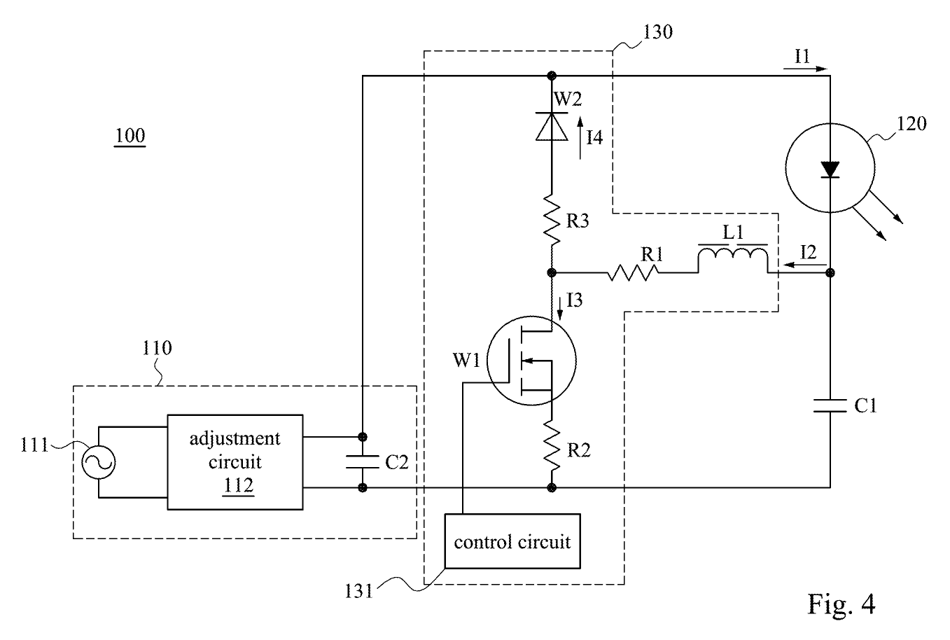

Please refer to FIG. 4, which is another embodiment of the light emitting element driving device 100 of the present disclosure. The light emitting element driving device 100 includes an energy storage element C1, a power source 110, and a converter circuit 130. The functions of the energy storage element C1, the inductance L1, the power source 110, the light emitting element 120, the converter circuit 130, the first switch element W1, the second switch element W2, and the control circuit 131 are similar to the embodiment shown in FIG. 1 so it will not be described here.

Compared to the embodiment shown in FIG. 1, the converter circuit 130 further includes at least one detection element (e.g., R1, R2, or R3 shown in FIG. 4). The detection element is electrically connected to the first switch element W1, the second switch element W2, and the inductance L1 in order that there is a detection current flow through the detection element. The first switch element W1 is turned on in the first operational status or turned off in the second operational status according to the magnitude of the detection current. In some embodiments, the detection element includes a resistance or current transformer, but not limited thereto.

In some embodiments, as shown in FIG. 4, the converter circuit 130 includes a first detection element R1, a second detection element R2, and a third detection element R3. The first detection element R1 is connected in series with the inductance L1 for the second current I2 to flow through. The second detection element R2 is connected in series with the first switch element W1 for the third current I3 to flow through. The third detection element R3 is connected in series with the second switch element W2 for the fourth current I4 to flow through.

As described above, if the converter circuit 130 is operated in the BCM, the first current I1 on the light emitting element 120 is equal to half of the peak current in the converter circuit 130 (e.g., the peak value of the second current I2 flowing through the inductance L1). Therefore, in some embodiments, the converter circuit 130 detects a current (e.g., second current I2, third current I3, or fourth current I4) flowing through at least one of the first switch element W1, the second switch element W2, and the inductance L1, and then, controls the first switch element W1 to turn on or off according to the detection current. For example, if the light emitting element 120 emits an ideal light intensity and the required first current I1 is 1050 mA, the light emitting element driving device 100 can set twice the first current I1 as a default value (e.g., 2100 mA). When the converter circuit 130 detects that the detection current reaches a default value, the control circuit 131 controls the first switch element W1 to turn off so that the converter circuit 130 is in the second operation state. In other embodiments, the light emitting element 120 may electrically connected in series with a current detecting element (e.g., a resistor), so that the converter circuit 130 may detect the first current I1 on the light emitting element 120, and control the first switch element W1 to turn off when the first current I1 reaches a default value.

The present disclosure can stably maintain the first current I1 flowing through the light emitting element 120. In other embodiments, when the light intensity of the light emitting element 120 needs to be adjusted, the first current I1 on the light emitting element 120 may be changed correspondingly by changing the value of the default value. Referring to FIG. 3, when the default value changes, the time point for the converter circuit 130 to enter the second operational status will also change. For example, by increasing the default value (e.g., increasing to 2300 mA), the charging period T1 will be extended, and the first current I1 on the light emitting element 120 will also increase (e.g., 1150 mA, half of 2300 mA). In this way, the light intensity emitted by the light emitting element 120 can be accurately changed to realize the light adjustment function.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A light emitting element driving device, comprising:
an energy storage element;
a power source electrically connected to a positive terminal of the energy storage element through a light emitting element in order to provide a current to the light emitting element and to charge the energy storage element; and
a converter circuit electrically connected to the power source and the energy storage element, wherein the converter circuit comprises an inductance;
wherein when the converter circuit is in a first operational status, the energy storage element charges the inductance, and when the converter circuit is in a second operational status, the inductance is discharged to the power source.

2. The light emitting element driving device of claim 1, wherein the converter circuit further comprises:
a first switch element electrically connected to the inductance and the energy storage element, wherein when the first switch element is turned on, the energy storage element charges the inductance.

3. The light emitting element driving device of claim 2, wherein the converter circuit further comprises:
a second switch element electrically connected to the inductance and the power source, wherein when the second switch element is turned on, the inductance is configured to discharge to the power source.

4. The light emitting element driving device of claim 3, wherein the converter circuit further comprises:
at least one detection element electrically connected to one of the first switch element, the second switch element and the inductance in order that a detection current flows through the at least one detection element;
wherein the first switch element is turned on in the first operational status or turned off in the second operational status according to the detection current.

5. The light emitting element driving device of claim 4, wherein the at least one detection element comprises a resistor or a current transformer.

6. The light emitting element driving device of claim 4, wherein the at least one detection element comprises:
a first detection element electrically connected to the inductance in series;
a second detection element electrically connected to the first switch element in series; and
a third detection element electrically connected to the second switch element in series.

7. The light emitting element driving device of claim 3, wherein the second switch element comprises a diode.

8. The light emitting element driving device of claim 3, further comprising:
a control circuit configured to control the first switch element to turn on or turn off according to a detection current flow through at least one of the first switch element, the second switch element and the inductance.

9. The light emitting element driving device of claim 1, wherein the energy storage element comprises a capacitor.

10. The light emitting element driving device of claim 1, wherein the power source comprises:
an AC voltage source;
an adjustment circuit electrically connected to the AC voltage source so as to receive an AC voltage from the AC voltage source and output an adjustment voltage; and
an input capacitor electrically connected to the adjustment circuit and configured to receive the adjustment voltage.

11. A driving method of a light emitting element, comprising:
providing a current to a light emitting element through a power source and charging an energy storage element, wherein the power source is electrically connected to a first terminal of the light emitting element, and a positive terminal of the energy storage element is directly connected to a second terminal of the light emitting element;
turning on a first switch element in order that the energy storage element charges a inductance when the power source provides the current to the light emitting element continuously; and
turning off the first switch element in order that the inductance discharges to the power source.

12. The driving method of claim 11, wherein after turning off the first switch element, the inductance discharges to the power source through a second switch element.

13. The driving method of claim 12, further comprising:
detecting a detection current flow through at least one of the first switch element, the second switch element and the inductance; and
controlling the first switch element to turn on or turn off according to the detection current.

14. The driving method of claim 13, further comprising:
controlling the first switch element to turn off according to the detection current when the detection current reaches a default value.

15. A light emitting element driving device, comprising:
an energy storage element;
a power source electrically connected to a positive terminal of the energy storage element through a light emitting element in order to provide a current to the light emitting element and to charge the energy storage element; and
a inductance electrically connected to the energy storage element;
a first switch element electrically connected to the energy storage element and the inductance, wherein the energy storage element is configured to charge the inductance when the first switch element is turned on; and
a second switch element electrically connected to the inductance and the power source, wherein the inductance discharges to the power source through the second switch element when the first switch element is turned off.

16. The light emitting element driving device of claim 15, wherein the energy storage element comprises a capacitor.

17. The light emitting element driving device of claim 15, wherein the power source comprises an input capacitor, and the input capacitor is configured to provide energy to the light emitting element and the energy storage element.

18. The light emitting element driving device of claim 15, further comprising:
at least one detection element electrically connected to one of the first switch element, the second switch element and the inductance in order that a detection current flow through the at least one detection element;
wherein the first switch element is turned off according to the detection current.
